(19) United States
(12) Patent Application Publication
(10) Pub. No.: US 2004/0229086 A1
(43) Pub. Date: Nov. 18, 2004

(54) Magnetic recording medium and method for producing the same

(75) Inventors: Masatoshi Takahashi, Kanagawa (JP); Yasushi Hattori, Kanagawa (JP); Koukichi Waki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/845,258

(22) Filed: May 14, 2004

(30) Foreign Application Priority Data
May 16, 2003 (JP) 2003-139244

(51) Int. Cl. B32B 1/00; G11B 5/66; G11B 5/70

(52) U.S. Cl. 428/694 TS; 428/694 R; 428/694 MT

(57) ABSTRACT

The present invention provides a method for producing a magnetic recording medium having a magnetic layer on a substrate containing polybenzoxazole, wherein the magnetic layer is sequentially formed by: preparing alloy particles capable of forming ferromagnetic regular alloys having a CuAu or Cu₃Au crystal structure; forming a coating film by applying the alloy particles on the substrate; and converting the alloy particles into magnetic particles by annealing the coating film so that the alloy particles are annealed. The invention also provides a magnetic recording medium having a magnetic layer which contains magnetic particles having ferromagnetic regular alloys having a CuAu or Cu₃Au crystal structure and is produced by the method. A step for oxidizing the alloy particles is preferably provided between preparing the alloy particles and annealing the coating film.

### CROSS-REFERENCE TO RELATED APPLICATIONS

This application claims benefit of and priority to Japanese Patent Application No. 2003-139244, filed on May 16, 2003, which is incorporated herein by reference in its entirety for all purposes.

### BACKGROUND OF THE INVENTION

1. Field of the Invention

The present invention relates to a magnetic recording medium and a method for producing the magnetic recording medium.

2. Description of the Related Art

Reducing particle sizes is essential for enhancing magnetic recording density. For example, when the weight of ferromagnetic body is the same, noise levels are decreased by reducing the particle size in magnetic recording media which are widely used for video tapes, computer tapes and disks. Ferromagnetic regular alloys having a CuAu or Cu₃Au crystal structure are promising for improving magnetic recording density since the alloys exhibit large crystalline magnetic anisotropy due to distortion generated in a ordering process to enable, whereby ferromagnetic properties are displayed even when the particle size id reduced.

On the other hand, a magnetic recording medium is required to be inexpensive as well as having a high magnetic recording density. However, since alloys for forming ferromagnetic regular alloys having a CuAu or Cu₃Au crystal structure contain noble metals, the price of the magnetic material becomes too high to comply with such a requirement.

Accordingly, it has been considered to use an inexpensive organic substrate, which is suitable as a substrate for a floppy (R) disk due to its flexibility.

However, nano-particles (which herein refer to alloy particles for forming the ferromagnetic regular alloys having a CuAu or Cu₃Au crystal structure) synthesized by a liquid phase method or vapor phase method have a disordered phase, and consequently, the particles must be annealed at a temperature of 500° C. or more in order to obtain an ordered phase that exhibits ferromagnetic properties. However, an organic substrate having low heat resistance may be deformed or denatured by annealing at the high temperature described above.

A method for annealing only the nano-particles before applying them to the organic substrate together with a binder has been disclosed (for example see Japanese Patent Application Laid-Open (JP-A) No. 2002-157727). However, this method is not practical because the particles are often fused to one another in the step for independently annealing the nano-particles.

### SUMMARY OF THE INVENTION

The present invention has been made in view of the above and provides a magnetic recording medium having a high magnetic recording density without deformation and deterioration of the substrate by annealing while affording a high output power.

The present inventors found, through intensive studies for solving the problems, that the problems described above can be solved by the invention set forth below.

The invention provides a magnetic recording medium having a magnetic layer containing magnetic particles having ferromagnetic regular alloys having a CuAu or Cu₃Au crystal structure, on a substrate, wherein the substrate contains polybenzoxazole, and the magnetic layer is sequentially formed by: preparing alloy particles capable of forming the ferromagnetic regular alloys having a CuAu or Cu₃Au crystal structure; forming a coating film by applying the alloy particles on the substrate; and converting the alloy particles into magnetic particles by annealing the coating film so that the alloy particles are annealed.

Further, the invention provides a method for producing a magnetic recording medium having a magnetic layer on a substrate containing polybenzoxazole, wherein the magnetic layer is sequentially formed by: preparing alloy particles capable of forming ferromagnetic regular alloys having a CuAu or Cu₃Au crystal structure; forming a coating film by applying the alloy particles on the substrate; and converting the alloy particles into magnetic particles by annealing the coating film so that the alloy particles are annealed.

### DETAILED DESCRIPTION OF THE INVENTION

The magnetic recording medium of the present invention will be described in detail hereinafter.

The magnetic recording medium of the invention comprises on a substrate a magnetic layer containing magnetic particles having ferromagnetic regular alloys having a CuAu or Cu₃Au crystal structure, and the substrate comprises polybenzoxazole.

Since the substrate using polybenzoxazole as a material is an organic substance, it is inexpensive as compared with inorganic substrates comprising metals. Accordingly, the organic substrate is useful for producing the magnetic recording medium with high productivity. The magnetic recording medium of the invention comprising the organic substrate can be favorably used for floppy (R) disks or the like due to its flexibility.

Polybenzoxazole has greater heat resistance than conventionally used organic substrates since it is resistant up to 650° C. Consequently, magnetic characteristics of the magnetic layer formed on the substrate are maintained in a high state to afford high output, since the substrate is not deformed or denatured by applying an annealing treatment described below.

Polybenzoxazole (PBO) is a polymer having a benzoxazole ring in the main chain. Representative examples of the compound can be obtained by dehydration condensation between 3,3-dihydroxybenzidine and an aromatic or aliphatic dicarboxylic acid in polyphosphoric acid. The polymer has a repeating unit represented by the following formula (I).

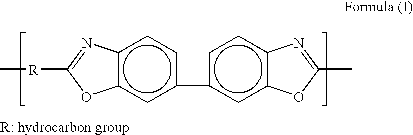

Specific examples of polybenzoxazole represented by the formula (I) include poly-p-phenylene benzoxazole and polyoctamethylene benzoxazole. Examples of other polybenzoxazole include those having the repeating units represented by the following formulae (II) and (III). However, poly-p-phenylene benzoxazole is preferable considering heat resistance and strength.

A thickness of the substrate is preferably in a range of 0.002 to 0.100 mm, though the thickness is preferably defined dependent to the material of the substrate.

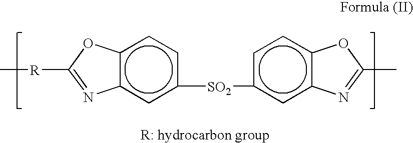

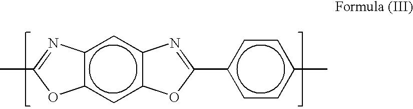

The magnetic layer of the magnetic recording medium of the invention is formed on the substrate through the following process.

The magnetic layer is formed on the substrate by sequentially preparing alloy particles capable of forming ferromagnetic regular alloys having a CuAu or Cu₃Au crystal structure; applying the alloy particles on the substrate to form a coating film; and converting the alloy particles into magnetic particles by annealing the coating film in a reducing atmosphere.

An oxidation step for oxidizing the alloy particles is preferably provided between the alloy particle preparation and annealing for facilitating annealing at a low temperature. The steps will be described below in the order of the processes.

Step for Producing Alloy Particles

The alloy particles converted into magnetic particles by annealing are prepared by the vapor phase or liquid phase method. However, the liquid phase is preferable considering excellent compatibility to mass production. While known various methods may be employed for the liquid phase method, reduction methods as improved methods of the liquid phase methods are preferably employed, and an inverse micelle method is particularly preferable among the reduction methods since the particle diameter can be readily controlled.

Inverse Micelle Method

The inverse micelle method at least comprises (1) applying a reducing reaction to a mixture of two inverse micelle solutions, and (2) aging the solution at a given temperature after the reducing reaction.

Each step will be described below.

(1) Reduction Step

An inverse micelle solution (I) is prepared in the first step by mixing a non-aqueous organic solvent containing a surfactant and an aqueous reductant solution.

An oil-soluble surfactant is used as the surfactant. Specific examples of the surfactant include sulfonic acid surfactants (for example, “Aerosol OT” (trade name, manufactured by Wako Pure chemical Industries, Inc.), quaternary ammonium salt surfactants (for example cetyltrimethylammonium bromide), and ether surfactants (for example pentaethyleneglycol dodecylether).

The content of the surfactant in the non-aqueous organic solvent is preferably 20 to 200 g/liter.

Preferable examples of the non-aqueous organic solvents capable of dissolving the surfactant include alkanes, ethers and alcohols, and the like.

Alkanes having 7 to 12 carbon atoms are preferable. Specific examples of them include heptane, octane, isooctane, nonane, decane, undecane and dodecane.

Preferable examples of the ethers include diethylether, dipropylether and dibutylether.

Preferable examples of the alcohols include ethoxyethanol and ethoxypropanol.

The reductant used as the aqueous reductant solution contains alcohols, polyalcohols, H₂, HCHO, S₂O₆²⁻, H₂PO₂⁻, BH₄−, N₂H₅⁺ and H₂PO₃. These compounds may be used alone, or in a combination thereof.

The content of the reductant in the aqueous solution is preferably 3 to 50 moles relative to 1 mole of the metal salt.

The mass ratio of water to the surfactant (water/surfactant) in the inverse micelle solution (I) is preferably 20 or less. The mass ratio of 20 is advantageous for suppressing precipitates from being formed and for making the particle diameter uniform. The mass ratio is preferably 15 or less, more preferably 0.5 to 10.

Then, an inverse micelle (II) is independently prepared by mixing a non-aqueous organic solvent containing the surfactant and an aqueous metal salt solution.

The surfactant and the condition of the non-aqueous organic solvent (the substance used and concentration) are the same a sin preparing the inverse micelle (I).

The inverse micelle solution (II) may be the same as or different from the inverse micelle (I), so long as the condition is within the range above. The mass ratio of water to the surfactant in the inverse micelle solution (II) is also in the same range as that in the inverse micelle solution (I), and the mass ratio of the inverse micelle solution (II) may be the same as or different from the mass ratio of the inverse micelle solution (I).

Preferably, the metal slat contained in the aqueous metal salt solution is appropriately selected so that the magnetic particles to be prepared are able to form the ferromagnetic regular alloys having a CuAu or Cu₃Au crystal structure.

Examples of the ferromagnetic regular alloy having a CuAu crystal structure include FeNi, FePd, FePt, CoPt and CoAu alloys, and FePd, FePt and CoPt are preferable among them.

Examples of the ferromagnetic regular alloy having a Cu₃Au crystal structure include Ni₃Fe, FePd₃, Fe₃Pt, FePt₃, CoPt₃, Ni₃Pt, CrPt₃ and Ni₃Mn, and FePd₃, FePt₃, CoPt₃, Fe₃Pd, Fe₃Pt and Co₃Pt are preferable among them.

Specific examples of the metal salt include H₂PtCl₅, K₂PtCl₄, Pt(CH₃COCHCOCH₃)₂, Na₂PdCl₄, Pd(OCOCH₃)₂, PdCl₂, Pd(CH₃COCHCOCH₃)₂, HAuCl₄, Fe₂(SO₄)₃, Fe(WO₃)₃, (NH₄)₃Fe(C₂O₄)₃, Fe(CH₃COCHCOCH₃)₃, NiSO₄, CoCl₂ and Co(OCOCH₃)₂.

The concentration of the metal salt in the aqueous solution is preferably 0.1 to 1000 μmol/ml, more preferably 1 to 100 μmol/ml.

The alloy particles capable of forming ferromagnetic regular alloys having a CuAu or Cu₃Au crystal structure, in which poor metals and noble metals form an alloy, can be prepared by appropriately selecting the metal salts.

While the alloy particles should be transformed from a disordered phase to an ordered phase by annealing to be described below, a third element such as Sb, Pb, Bi, Cu, Ag, Zn and In are preferably added to the binary alloy for lowering the transform temperature. It is preferable to previously add a precursor of the third element into the metal salt solution. The amount of addition of the third element is preferably 1 to 30 at %, more preferably 5 to 20 at %, relative to the amount of the binary alloy.

The inverse micelle solutions (I) and (II) prepared as described above are mixed with each other. While the mixing method is not particularly restricted, it is preferable to add the inverse micelle solution (II) while the inverse micelle solution (I) is stirred. The temperature for allowing the reducing reaction to proceed after the mixing is preferably constant in the range of −5 to 30° C.

Controlling the reduction temperature in the range of −5 to 30° C. permits the reducing reaction to be prevented from being heterogeneous by condensation of the aqueous phase, while the temperature range above is advantageous for suppressing coagulation or precipitation from occurring. A temperature range of 0 to 25° C. is preferable, and a temperature range of 5 to 25° C. is more preferable.

The term “constant temperature” as used herein means that the setting temperature T (° C.) is in the range of T±3° C. The upper limit and lower limit of the temperature T is in the reduction temperature above (−5 to 30° C.), even when the accuracy of the temperature is determined as described above.

While the reducing reaction time should be determined depending on the amount of the inverse micelle solution, it is preferably 1 to 30 minutes, more preferably 5 to 20 minutes.

The reducing reaction is preferably proceeded at a stirring rate as high as possible, since the stirring rate largely affect monodispersity of the particle diameter distribution.

Preferably, a stirring device capable of giving a high shear force is used. Practically, the stirring wing basically has a turbine or paddle shape structure, a sharp edge is provided at the end of the wing or at a position in contact with the wing, and the wing is rotated with a motor. Specific examples of such stirring device include a dissolver (manufactured by Tokushu Kika Kogyo Co., Ltd.), Omnimixer (trade name, manufactured by Yamato Scientific Co., Ltd.), and a homogenizer (manufactured by SMT Co., Ltd.). A stable dispersion solution of the monodisperse alloy particles may be prepared by using these devices.

Preferably, at least one dispersant having 1 to 3 amino groups or carboxyl groups is added in at least one of the inverse micelle solutions (I) and (II) in a proportion of 0.001 to 10 mole relative to 1 mole of the alloy particles to be prepared.

Such dispersant permits monodisperse alloy particles to be obtained without coagulation.

When the amount of addition of the dispersant is less than 0.001 mole relative to 1 mole of the alloy particles, monodispersibility of the alloy particles is not necessarily improved. When the amount of addition of the dispersant exceeds 10 mole relative to 1 mole of the alloy particles, coagulation of the alloy particles may occur.

Organic compounds having adsorbing groups to the surface of the alloy particles are preferable as the dispersant. Specific examples of the adsorbent include the compounds having 1 to 3 amino, carboxyl, sulfonic or sulfinic groups. These compounds may be used alone, or in a combination thereof.

The compounds contain structural formula represented by R—NH₂, NH₂—R—NH₂, NH₂—R(NH₂)—NH₂, R—COOH, COOH—R—COOH, COOH—R(COOH)—COOH, R—SO₃H, SO₃H—R—SO₃H, SO₃H—R(SO₃H)—SO₃H, R—SO₂H, SO₂H—R—SO₂H and SO₂H—R(SO₂H)—SO₂H. R in the formula represents a linear, branched or cyclic hydrocarbon.

Oleic acid is a particularly preferable compound as the dispersant. Oleic acid is a known surfactant for stabilizing colloids, and has been used for protecting metal particles such as iron particles. The relatively long chain of oleic acid (for example, oleic acid has a chain having 18 carbon atoms with a length of at most about 20 angstrom (at most 2 mm); oleic acid has one double bond) is able to give a crucial steric hindrance for extinguishing a strong magnetic interaction among the particles.

Similar long chain carboxylic acids such as erucic acid and linoleic acid are used likewise oleic acid (for example, long chain organic acids having 8 to 22 carbon atoms may be used alone or in a combination thereof). Oleic acid is preferable since it is readily available from natural resources (for example olive oil). Oleylamine derivatives from oleic acid is also a useful dispersant as oleic acid is.

Metals having a low redox potential such as Co, Fe, Ni and Cr (metals having an redox potential of lower than −0.2 V (vs. N.H.E)) in the ferromagnetic regular alloys having a CuAu or Cu₃Au crystal structure are reduced in the reduction step as described above, and the metals are considered to be precipitated in a monodisperse state having a minute size. Metals having a high redox potential such as Pt, Pd and Rh (metals having an redox potential of higher than −0.2 V (vs. N.H.E))are reduced with the metals having a lower redox potential in the temperature increase step and aging step thereafter, and are precipitated using the precipitated metals having a lower redox potential as nuclei on the surface thereof. The ionized metals having a lower redox potential are considered to be precipitated by being reduced with the reductant again. The alloy particles capable of forming the ferromagnetic regular alloys having a CuAu or Cu₃Au crystal structure are obtained by repeating the process above.

(2) Aging Step:

The solution after the reaction is heated to an aging temperature after completing the reducing reaction.

The aging temperature is preferably a constant temperature of 30 to 90° C., and the temperature is higher than the reducing reaction temperature. The aging time is preferably 5 to 180 minutes. Coagulation or precipitation tends to occur when the aging temperature and time shift to a higher side, while the reaction is not completed to cause a change of the composition when the aging temperature and time shift to a lower side. The preferable aging temperature and time are preferably 40 to 80° C. and 10 to 150 minutes, respectively, and more preferably 40 to 70° C. and 20 to 120 minutes, respectively.

While the term “constant temperature” as used herein has the same meaning as used in the reducing reaction temperature (the “reducing temperature” is changed to an “aging temperature” herein), the aging temperature is preferably 5° C. or more, more preferably 10° C. or more, higher than the reducing reaction temperature within the aging temperature range (30 to 90° C.) described above. The composition as described in the formulation may be readily obtained by adjusting the temperature to be 5° C. or more higher than the reducing reaction temperature.

The poor metals are precipitated in the aging step on the noble metals precipitated in the reduction step.

This means that the poor metals is reduced only on the noble metals without independently precipitating both kinds of metals to one another. Accordingly, the alloy powders capable of efficiently produce the CuAu or the Cu₃Au type ferromagnetic ordered alloy can be obtained in a high yield according to the formulated composition ratio that can be controlled as desired. The diameter of the alloy particles may be controlled as desired by properly controlling the temperature and stirring rate in the aging step.

Preferably, the solution after aging is washed with a mixed solution of water and a primary alcohol, and a precipitate is formed by a precipitation treatment using the primary alcohol, and the precipitate is dispersed in an organic solvent with the organic solvent.

Providing this washing and dispersion step permits impurities to be removed, and applicability for forming the magnetic layer of the magnetic recording medium is improved.

The washing and dispersion step is applied once, preferably twice or more.

While the primary alcohol used for washing is not particularly restricted such as methanol and ethanol are preferable. The mixing ratio (water/primary alcohol, volume ratio) is preferably in the range of 10/1 to 2/1, more preferably in the range of 5/1 to 3/1. Adjusting the mixing volume ratio in the range of 10/1 to 2/1 permits the surfactant to be readily removed to enable coagulation to be suppressed from occurring.

The alloy particles dispersed in a solution (an alloy particle-containing solution) is obtained as described above.

Since the alloy particles are monodisperse particles, they are not coagulated by applying on the substrate, and maintain their uniformly dispersed state. Accordingly, the alloy particles can be efficiently magnetized since they are not coagulated by the annealing treatment with good applicability.

While the diameter of the alloy particles before an oxidation treatment to be described below is preferably small for lowering the noise level, the particles become super paramagnetic after annealing when the particle diameter is too small to make the particles not suitable for magnetic recording. The particle diameter is preferably 1 to 100 nm, more preferably 1 to 20 nm, and particularly 3 to 10 nm.

Reducing Method

While various methods have been used for producing the alloy particles capable of forming the ferromagnetic regular alloys having a CuAu or Cu₃Au crystal structure have been known, preferably applicable method comprises the step of reducing a metal having a lower redox potential (referred to a noble metal hereinafter) and a metal having a higher redox potential (referred to a poor metal hereinafter) are reduced in an organic solvent or water, or in a mixed solvent of water and an organic solvent, using a reductant.

The order of reduction between the noble metal and poor metal is not particularly restricted, and both metals may be simultaneously reduced.

Alcohols and polyalcohols may be used as the organic solvents above. Examples of the alcohol include methanol, ethanol and butanol, while examples of the polyalcohol include ethyleneglycol and glycerin.

The CuAu type or Cu₃Au type ferromagnetic ordered alloy obtained by the reducing method is the same as that obtained by the inverse micelle method.

The methods described in Japanese Patent Application No. 2001-269255, paragraph No. 18 to 30 may be applied for preparing the alloy particles by permitting the poor metal first.

Pt, Pd and Rh can be preferably used as the metal having a high redox potential, and compounds such as H₂PtCl₆—6H₂O, Pt(CH₃COCHCOCH₃)₂, RhCl₃—3H₂O, Pd(OCOCH₃)₂, PdCl₂ and Pd(CH₃COCHCOCH₃)₂ may be used by dissolving in a solvent. The concentration of the metal in the solution is preferably 0.1 to 1,000 μmol/ml, preferably 0.1 to 100 μmol/ml.

Co, Fe, Ni and Cr, particularly Fe and Co, can be preferably used as the metal having a low redox potential, and compounds such as FeSO₄.7H₂O, NiSO₄.7H₂O, CoCl₂.6H₂O and Co(OCOCH₃)₂.4H₂O may be used by dissolving in a solvent. The concentration of the metal in the solution is preferably 0.1 to 1,000 μmol/ml, preferably 0.1 to 100 μmol/ml.

It is preferable to reduce the transformation temperature to the ferromagnetic ordered alloy by adding a third element in the binary alloy as in the inverse micelle method. The amount of addition is also the same as in the inverse micelle method.

For example, it is preferable that the low potential metals, or the low potential metals and a part of the high potential meals are reduced using a reductant having a lower redox potential than −0.2 V (vs. N.H.E), the reduced metals are added to a high potential metal source to reduce the high potential metals by adding a reductant having a higher redox potential than −0.2 V (vs. N.H.E), and the remaining high potential metals are reduced by adding a reductant having a lower redox potential than −0.2 V (vs. N.H.E), when the low potential metals and high potential metals are precipitated by reduction in this order.

While the redox potential depends on the pH of the solution, alcohols such as 1,2-hexadecanediol, glycerin, H₂ and HCHO are preferably used for the reductant having a higher redox potential than −0.2 V (vs. N.H.E).

S₂O₆²⁻, H₂PO₂⁻, BH₄⁻, N₂H₅⁻ and H₃PO₃⁻ are preferably used for the reductant having a lower redox potential than −0.2 V (vs. N.H.E).

No special reductant of metals is not needed when zero-valent metals such as Fe-carbonyl are used as the starting materials of the base potential metals.

The alloy particles can be stably prepared by adding an adsorbent for precipitating high potential metals by reduction. Polymers and surfactants are preferably used as the adsorbent.

Examples of the polymer include polyvinyl alcohol (PVA), poly-N-vinyl-2-pyrroridone PVP) and gelatin. PVP is particularly preferable among them.

The molecular weight of the polymer is preferably 20,000 to 60,000, more preferably 30,000 to 50,000. The amount of the polymer is preferably 0.1 to 10 times, more preferably 0.1 to 5 times, of the mass of the alloy particles formed.

The surfactant preferably used as the adsorbent preferably contains an “organic stabilizer” as a long chain organic compound represented by a general formula of R—X. R in the general formula is a “tail group” as a straight chain hydrocarbon, a branched hydrocarbon or fluorocarbon chain, and usually contains 8 to 2 carbon atoms. X in the general formula is a “head group” as a part (X) that provides a specific chemical bond on the surface of the alloy particles, and is preferably any one of sulfinate (—SOOH), sulfonate (—SO₂OH), phosphinate (—POOH), phosphonate (—OPO(OH)₂), carboxylate and thiol.

The organic stabilizer is preferably any one of sulfonic acid (R—SO₂OH), sulfinic acid (R—SOOH), phosphinic acid (R₂POOH), phosphonic acid (R—OPO(OH)₂), carboxylic acid (R—COOH) and thiol (R—SH). Oleic acid is preferable among them as in the inverse micelle method.

A combination of the phosphine and organic stabilizer (such as triorgano-phosphine/acid) can afford excellent controllability to growth and stability of the particles. While didecylether and didodecylether are also available, phenylether or n-octylether is favorably used as a solvent since it is inexpensive and has a high boiling point.

The reaction is preferably performed in a temperature range of 80 to 360° C., more preferably 80 to 240° C., depending on the require alloy particles and boiling point of the solvent. A temperature range of 80 to 360° C. enables growth of the particles to be accelerated while undesirable by-products are suppressed from being formed.

The diameter of the alloy particles is the same as that in the inverse micelle method, and is preferably 1 to 100 nm, more preferably 3 to 20 nm, and particularly 3 to 10 nm.

A seeding method is effective for increasing the particle size (particle diameter). It is preferable for increasing the recording capacity of the magnetic recording medium to put the alloy particles into a close-packed state. Accordingly, the standard deviation of the alloy particle size is preferably less than 10%, and more preferably less than 5%. The variation coefficient of the particle size is preferably 10% or less, more preferably 5% or less.

Too small particle size is not preferable since the particles become super paramagnetic. Accordingly, the seeding method is preferably used in order to increase particle size. However, since metals having a higher redox potential than the metals constituting the particles may be precipitated and the precipitated metals may be oxidized, the particles are previously subjected to hydrogenation.

While it is preferable that the outermost layer of the alloy particles comprise the noble metals for preventing oxidation, an alloy of the noble metals and base is preferably used in the invention in order to preventing the particles from being coagulated. Such construction of the particles may be readily and efficiently realized by the liquid phase method as described above.

The solution after forming the alloy particles is preferably desalted for improving dispersion stability of the alloy particles. Desalting is possible by adding an excess amount of an alcohol to allow the particles to be slightly coagulated followed by removing the salts together with the supernatant by spontaneous sedimentation or centrifugal sedimentation. However, an ultrafiltration method is preferably used since the sedimentation method tends to form coagulation.

The alloy particles dispersed in the solvent (alloy particle-containing solution) is obtained as described above.

A transmission electron microscope (TEM) is used for measuring the diameter of the alloy particles. While electron diffraction using TEM may be used for determining the crystal system of the alloy particles or magnetic particles, use of X-ray diffraction is preferable due to its high accuracy. The composition of the inside of the alloy particles or magnetic particles is preferably analyzed by FE-TEM (field emission transmission electron microscope) equipped with EDAX that permit the electron beam to be finely converged. Magnetic properties of the alloy particles or magnetic particles can be evaluated using VSM.

Oxidation Treatment

Oxidizing the alloy particles prepared permits the ferromagnetic particles to be efficiently produced without increasing the annealing temperature in a non-oxidative atmosphere to be applied hereinafter. This is conjectured to be caused by the phenomenon described below.

Oxygen invades into the crystal lattice by oxidizing the alloy particles. Oxygen invaded in the crystal lattice is eliminated by heat by annealing. Crystal defects are formed by eliminating oxygen, and displacement of the metal atoms constituting the alloy is facilitated through the crystal defects. Consequently, phase transformation is conjectured to readily occur at a relatively low temperature.

Such phenomenon may be speculated by a EXAFS (extended X-ray absorption fine structure) measurement of the alloy particles after oxidation and the magnetic particles after annealing.

Bonds between Fe atoms and Pt atoms or Fe atoms are confirmed to exist in the alloy particles before oxidizing with Fe—Pt particles.

On the contrary, bonds between the Fe atoms and oxygen atoms are confirmed in the alloy particles after oxidation. However, substantially no bonds between the Pt atoms and Fe atoms are observed. This means that the bonds of Fe—Pt and Fe—Fe are broken by the oxygen atoms, and the Pt atoms and Fe atoms became readily movable by annealing.

No oxygen is detected to exist after annealing the alloy particles, and the bonds between Fe atoms and Pt or Fe are confirmed around Fe atoms.

It may be comprehended from the phenomenon above that the annealing temperature is forced to be increased unless the particles are oxidized since phase transformation hardly occurs. However, excessive oxidation may result in formation of metal oxides since readily oxidized metals such as Fe too strongly interacts with oxygen by excessive oxidation.

Accordingly, it is important to control the oxidation state of the alloy particles, and a proper oxidation condition should be selected for this purpose.

A gas at least containing oxygen may be supplied to the alloy particles-containing solution or magnetic layer coating solution after preparation when the alloy particles are prepared by the liquid phase method.

The partial pressure of oxygen is preferably 10 to 100%, more preferably 15 to 50%, of the total pressure.

The oxidation temperature is preferably 0 to 100° C., more preferably 15 to 80° C.

A second oxidation treatment is preferably applied after applying the alloy particles on the substrate and before annealing to be described below. The alloy particles are allowed to stand in an oxygen atmosphere or in air at 0 to 80° C. for 1 to 24 hours. Such oxidation treatment is a relatively weak oxidation treatment. Oxygen defects (voids) are formed in an annealing treatment in a reducing atmosphere to be described below, and phase transformation is accelerated.

Coating

The particles are liable to be fused due to easy displacement of the particles when the particles are directly annealed. Therefore, the particle size tends to be increased, although a high coercive force is obtained. Accordingly, annealing is preferably applied by applying the particles on the substrate for preventing the alloy particles from being coagulated.

Preferably, various additives are added, if necessary, in an alloy particle-containing solution after applying the oxidation treatment.

The content of the alloy particles in the the magnetic layer coating solution is preferably a desired concentration (0.01 to 0.1 mg/ml).

The coating method on the substrate available include air doctor coat, blade coat, rod coat, extrusion coat, air knife coat, squeeze coat, dip coat, reverse coat, transfer roll coat, gravure coat, kiss coat, cast coat, spray coat and spin coat methods.

Annealing

The alloy particles after oxidation have a random phase. Ferromagnetism cannot be obtained in the random phase as described above. Accordingly, the alloy particles are annealed for transferring into an ordered phase. The transformation temperature of the alloy constituting the alloy particles into the ordered phase is determined by differential thermal analysis (DTA), and the alloy is annealed at a temperature above the transformation temperature.

While the transformation temperature is usually about 500° C., the temperature may be decreased by adding a third element. The transformation temperature can be also decreased by appropriately changing the atmosphere for oxidation and annealing. Accordingly, the annealing temperature is preferably 150° C. or more, more preferably 150 to 500° C. Examples of the third element include Ag, Cu, Pb, Bi, and Sb.

The annealing treatment is preferably applied in a reducing atmosphere such as methane, ethane or other reducing atmosphere for forming the oxygen defects by performing phase transformation efficiently and eliminating oxygen on a crystal lattice incorporated by treating with oxygen. It is also preferable to control orientation of the magnetic material by annealing in a magnetic field. An inert gas such as N², Ar, He and Ne is mixed with the gas for forming the reducing atmosphere for preventing explosion (in a proportion of preferably 1 to 5% to the reducing atmosphere gas). However, the annealing time should be controlled when the inert gas is used since elimination of oxygen is slightly retarded.

Preferably, the particles are annealed once in the inert gas at a temperature equal to or below a transformation temperature for preventing the particles from being fused during the annealing treatment, and annealed at a temperature equal to or above the transformation temperature in the reducing atmosphere after a dispersant has been carbonized.

In a preferable embodiment, a binder such as a Si-based resin and PVP may be added in a dispersion solution of the alloy particles, and the particles are annealed after applying the solution for preventing the particles from being fused to one another.

By the annealing treatment as described above, the alloy particles are transformed from a disordered phase to an ordered phase, ferromagnetic particles are obtained and a magnetic recording medium having a magnetic layer containing the magnetic particles on a substrate may be obtained.

Since a highly heat resistant substrate is used for the magnetic recording medium prepared, the substrate does not suffer denaturation and deformation caused by manufacturing conditions (for example annealing at high temperatures), and is inexpensive and is hardly cracked as compared with inorganic substrates such as Si and a glass substrate.

The magnetic particles produced as described above preferably have a coercive force of 95.5 to 398 kA/m (1,200 to 5,000 Oe), and a coercive force of 95.5 to 278.6 kA/m (1,200 to 3,500 Oe) is more preferable considering application to the magnetic recording medium.

The particle diameter of the magnetic particles is preferably 1 to 100 nm, more preferably 3 to 20 nm, and particularly 3 to 10 nm.

While examples of the magnetic recording medium as described above include magnetic tapes such as a video tape and computer tape, and magnetic disks such as a floppy (R) disk and hard disk, the medium is preferably applied for the floppy (R) disk by taking advantage of the flexibility of the substrate.

The thickness of the magnetic layer formed after annealing is preferably 4 nm to 1 μm, more preferably 4 to 100 nm, although the thickness depends on the kind of the magnetic recording medium to which the magnetic layer is applied.

The magnetic recording medium of the invention may comprise other layers in addition to the magnetic layer, if necessary. For example, another magnetic layer and nonmagnetic layer are preferably provided on the surface at the opposite side of the magnetic layer in case of disk. A back layer is preferably provided on an insoluble substrate surface at the opposite side of the magnetic layer in the case of tapes.

Wear resistance is improved by forming a very thin protective layer on the magnetic layer, and a sufficiently reliable magnetic recording medium can be formed by enhancing lubricity by applying a lubricant on the protective layer.

While examples of the material of the protective layer include oxides such as silica, alumina, titania, zirconia, cobalt oxide and nickel oxide; nitrides such as titanium nitride, silicon nitride and boron nitride; carbide such as silicon carbide, chromium carbide and boron carbide; and carbon such as graphite and amorphous carbon, the material specifically preferably contains hard non-crystal carbon, which is generally called diamond-like carbon.

The carbon protective layer comprising carbon is suitable as the material of the protective layer, since it has a sufficient wear resistance even when it is a very thin film, and causes no seizing on a sliding member.

While sputtering methods are usually used for forming the carbon protective layer in the hard disk, various methods using plasma CVD have been proposed in the product that require continuous film deposition such as video tapes. Accordingly, these methods are preferably employed/

Plasma injection CVD (PI-CVD) has a very large film deposition rate among the CVD methods, and it has been reported that the quality of the carbon protective layer obtained is excellent in that it is hard and contains small number of pine holes (for example see JP-A Nos. 61-130487, 63-279426 and 3-113824).

The carbon protective layer preferably has a Vickers hardness of preferably 1000 kg/mm² or more, more preferably 2000 kg/mm² or more. The crystal stricture is preferably amorphous and non-conductive.

When the carbon protective layer is formed as a diamond-like carbon film, the structure of the film can be confirmed by Raman spectroscopy, or by confirming that a peak appears at 1520 to 1560 cm⁻¹ by the Raman spectroscopic measurement of the diamond-like carbon film. When the carbon film does not have the diamond-like carbon structure, the peak detected by Raman spectroscopy shifts from the region above, and the hardness of the protective layer decreases.

The carbon materials preferably used for forming the carbon protective layer include alkanes such as methane, ethane, propane and butane; alkenes such as ethylene, propylene; alkyns such as acetylene; and various carbon-containing compounds. A carrier gas such as argon and added gases such as hydrogen and nitrogen for improving the film quality may be added.

Electromagnetic conversion characteristics and adhesive property to the magnetic layer are deteriorated when the carbon protective layer has a large thickness of the film, while wear resistance is insufficient when the thickness of the film is small. Accordingly, the thickness of the film is preferably 2.5 to 20 nm, more preferably 5 to 10 nm.

For improving the adhesive property of the protective layer to the magnetic layer as a substrate, the surface of the magnetic layer may be previously etched with an inert gas, or the surface is preferably transformed by exposing to a reactive gas plasma such as oxygen.

The magnetic layer may be laminated, or a known nonmagnetic underlayer or an intermediate layer may be formed under the magnetic layer for improving electromagnetic conversion characteristics. A lubricant layer and rust preventive layer are preferably applied on the magnetic layer or protective layer for improving running durability and corrosion resistance, as described above. The lubricant available for addition includes a hydrocarbon lubricant, a fluorine lubricant and an extreme-pressure additive.

Examples of the hydrocarbon lubricant include carboxylic acids such as stearic acid and oleic acid; esters such as butyl stearate; sulfonic acids such as octadecylsulfonic acid; phosphate esters such as monooctadecyl phosphate; alcohols such as stearyl alcohol and oleyl alcohol; carboxylic amides such as stearic acid amide; and amines such as stearylamine.

Examples of the fluorine lubricants preferably used in the invention include those in which a part or all of the alkyl groups in the hydrocarbon lubricants are substituted with fluoroalkyl groups or perfluoropolyether groups.

Examples of the perfluoropolyether group include perfluoromethylene oxide polymers, perfluoroethylene oxide polymers, perfluoro-n-propylene oxide polymers (CF₂CF₂CF₂O)ₙ, perfluoroisopropylene oxide polymers (CF(CF₃)CF₂O)ₙ, or copolymers thereof.

Compounds having polar functional groups such as hydroxyl groups, ester groups and carboxyl groups at the terminals of the alkyl group or in the molecules of the hydrocarbon lubricant are suitable for enhancing the effect for reducing the frictional force.

The molecular weight is in the range of 500 to 5,000, preferably 1,000 to 3,000. The molecular weight in the range of 500 to 5,000 enables volatility to be maintained low and lubricity to be maintained high, while adsorption between the slider and disk as well as occurrence of halt of running and head crash can be prevented.

Commercially available products by trade names FOMBLIN® manufactured by Ausimont Co. and KRYTOX® manufactured by Du Pont K.K. are specific examples of perfluoropolyethers.

Examples of the extreme-pressure additives include phosphate esters such as trilauryl phosphate; phosphite esters such as trilauryl phosphite; thiophosphite esters such as trilauryl thiophosphite and thiophosphate esters; and sulfur EP agents such as benzyl disulfide.

The lubricant may be used alone, or a combination with other compounds. The methods for applying these lubricants on the protective layer comprise a wire bar method, photogravure method, spin-coat method and dip-coat method after dissolving the lubricant in an organic solvent, or a vacuum evaporation method.

Examples of the rust preventive include nitrogen-containing heterocyclic compounds such as benzotriazole, benzoimidazole, purine and pyrimidine, and derivatives obtained by introducing alkyl side chains to the main frame of these compounds; and nitrogen and sulfur-containing heterocyclic compounds such as benzothiazole, 2-mercaptobenzothiazole, tetrazaindene compounds and thiouracil compounds, and derivatives thereof.

As is mentioned above, a back-coat layer (backing layer) may be provided on the surface of the nonmagnetic substrate having no magnetic layer when the magnetic recording medium is a magnetic tape. The back-coat layer is provided on the surface of the nonmagnetic substrate having no magnetic layer by applying a back-coat layer forming paint in which granular components such as an abrasive and an antistatic agent and a binder are dispersed in a known organic solvent.

Various inorganic pigments and carbon black may be used as the granular components. Resins such as nitrocellulose, phenoxy resins, vinyl chloride resins and polyurethane may be used as the binder alone or as a mixture thereof.

A known adhesive layer may be provided on the surface having a coating surface of the alloy particle-containing solution and the back-coat layer.

The magnetic recording medium of the invention obtained as described above has an average roughness along the center line of the surface of preferably 0.1 to 5 nm, more preferably 1 to 4 nm, at a cut-off value of 0.25 mm, since it is desirable for a high recording density magnetic recording medium to form the surface having a quite excellent surface smoothness.

Methods for obtaining such surface smoothness include a calender treatment applied on the surface after forming the magnetic layer for obtaining a surface having such smooth surface. A varnish treatment may be also applied.

The magnetic recording medium obtained may be punched with a punching machine, or may be cut into a desired size using a guillotine.

### EXAMPLE

While the invention is described in detail with reference to examples, the present invention is by no means restricted to these examples.

### Example 1

Preparation of FePt Alloy Particles

The following procedure was carried out in high purity N₂ gas.

In a reductant solution prepared by dissolving 0.76 g of NaBH₄ (manufactured by Wako Pure Chemical Industries, Inc.) in 16 ml of water (de-oxygenated to 0.1 mg/liter), an alkane solution prepared by mixing 10.8 g of di-2-ethylhexyl sodium sulfosuccinate (trade name: Aerosol OT, manufactured by Wako Pure Chemical Industries, Inc.), 80 ml of decane and 2 ml of oleilamine (manufactured by Tokyo Kasei Kogyo, Co.) was added to prepare an inverse micelle solution (I).

Into an aqueous metal salt solution prepared by dissolving 0.46 g of iron trioxalate triammonium (Fe(NH₄)₃ (C₂O₄)₃), manufactured by Wako Pure Chemical Industries, Inc.), and 0.38 g of potassium chloroplatinate (K₂PtCl₄) in 12 ml of water (de-oxygenated to 0.1 mg/liter), an alkane solution prepared by mixing 5.4 g of Aerosol OT (described above) and 40 ml of decane was mixed to prepare an inverse micelle solution (II).

The inverse micelle solution (I) was momentarily added in the inverse micelle solution (II) at 22° C. while stirring the inverse micelle solution (II) at high speed using a Omnimixer (manufactured by Yamato Scientific Co., Ltd.). The solution was aged thereafter by stirring with a magnetic stirrer by heating at 50° C. for 60 minutes 10 minutes after the addition.

Further added was 2 ml of oleic acid (manufactured by Wako Pure Chemical Industries, Inc.), and the solution was cooled to room temperature. The aqueous phase and oil phase was separated by adding 100 ml of water and 100 ml of methanol to break the inverse micelle. A dispersion in which the alloy particles are dispersed in the oil phase was obtained. The oil phase was washed with a mixed solution of 600 ml of water and 200 ml of methanol 5 times.

Thereafter the alloy particles were flocculated by adding 1100 ml of methanol for sedimentation the particles. The supernatant was removed, and the particles were dispersed again by adding 20 ml of heptane (manufactured by Wako Pure Chemical Industries, Inc.).

The procedure of sedimentation by adding 100 ml of methanol and 20 ml of heptane was repeated twice. An alloy particle-containing solution comprising water and a surfactant in a proportion (water/surfactant) of 2 was prepared by finally adding 5 ml of heptane.

The following results were obtained by measuring the yield, composition, volume average particle diameter and distribution (variation coefficient) of the alloy particles obtained.

The composition and yield were determined by ICP spectroscopy (induction coupling plasma spectroscopy).

The volume average particle diameter and particle diameter distribution were determined by a statistical processing after measuring the particles photographed by TEM (transmission electron microscope, manufactured by Hitachi, Ltd.).

The alloy particles used for the measurements were collected from the alloy particle-containing solution prepared, and were used after thoroughly drying by heating in an electric furnace.

Composition: FePt alloy with Pt content of 44.5 at %

Yield: 85%

Average particle diameter: 4.2 nm

Variation coefficient: 5%

Oxidation

An alloy particle-containing solution prepared was concentrated so that the content of the alloy particles is 4% by mass by vacuum evaporation. A first oxidation treatment was applied, after concentration and resuming an atmospheric pressure, by feeding oxygen gas in the alloy particle-containing solution for oxidizing the alloy particles. The amount of the solvent evaporated during the oxidation treatment was replenished by adding heptane. Oleylamine was added in a proportion of 0.04 ml per 1 ml of the alloy particle-containing solution after the oxidation treatment.

Coating

An alloy particle-containing solution prepared was concentrated so that the content of the alloy particles is 4% by mass by vacuum evaporation. The solution was applied in air on a substrate comprising polybenzoxazole with a thickness of 0.06 mm using a spin coater so that the content of the alloy particles is 0.5 g/m² to form a coating film. A second oxidation treatment was applied before annealing by exposing the substrate in air at 25° C. for 3 hours.

Annealing

The substrate was annealed after coating by heating in an electric furnace (550° C.) in a nitrogen gas atmosphere for 30 minutes at a heating rate of 50° C./min, and the substrate was cooled to room temperature at a cooling rate of 50° C./min. The magnetic recording medium having the magnetic layer (a thickness of 50 nm) containing magnetic particles was thus manufactured.

The bond length and bond number between Fe and oxygen was found to be 19.7 nm and 2.2, respectively, from an EXAFS (extended X-ray absorption fine structure) measurement of the alloy particles after oxidation.

### Example 2

The magnetic recording medium was manufactured by the same method as in Example 1, except that oxygen gas used in the first oxidation treatment was changed to a mixed gas of oxygen and nitrogen (O₂:N₂=1:1).

The bond length and bond number of between Fe and oxygen was found to be 19.8 nm and 1.8, respectively, from an EXAFS measurement of the alloy particles after oxidation.

### Example 3

The magnetic recording medium was manufactured by the same method as in Example 1, except that oxygen gas used in the first oxidation treatment was changed to air.

The bond length and bond number of between Fe and oxygen was found to be 19.9 nm and 1.5, respectively, from an EXAFS measurement of the alloy particles after oxidation.

### Example 4

The magnetic recording medium was manufactured by the same method as in Example 1, except that nitrogen gas used in the annealing treatment was changed to hydrogen gas and the heating temperature was changed to 500° C.

The bond length and bond number of between Fe and oxygen was found to be 19.7 nm and 2.1, respectively, from an EXAFS measurement of the alloy particles after oxidation.

### Example 5

The magnetic recording medium was manufactured by the same method as in Example 1, except that nitrogen gas used in the annealing treatment was changed to hydrogen gas, and the heating temperature was changed to 400° C.

### Comparative Example 1

The magnetic recording medium was manufactured by the same method as in Example 1, except that Uvilex S (trade name, polyimide manufactured by Ube Industries, Ltd.).

The magnetic property (coercive force: Hc) and crystal structure of the magnetic layer formed on each magnetic recording medium prepared in Examples 1 to 5 and Comparative Example 5 were evaluated. A volume average particle diameter of the magnetic particles was determined by scraping off the magnetic particles from the magnetic layer using a spatula. The results are shown in Table 1 below.

The following apparatuses were used for measuring the magnetic property, crystal stricture and particle diameter.

Magnetic property: high sensitivity magnetization spectrometer and data processing unit manufactured by Toei Industry Co., Ltd. Applied magnetic field of 790 kA/m (10 kOe).

Particle diameter: transmission electron microscope manufactured by Hitachi, Ltd., acceleration voltage 300 kV

Crystal structure: powder method using X-ray diffraction analyzer manufactured by Rigaku Corporation

Output (C/N) of the magnetic recording medium was evaluated by recording a 10 MHz signal at a rotation speed of 10,000 rpm using Spin Stand LS90 manufactured by Kyodo Electronics, Inc., by reproducing by MR head and by measuring the signal output of the recorded data. The results are shown in Table 1 below. In the evaluation criteria in Table 1, “Yes” denotes that the regenerated signal was obtained, while “No” denotes that the regenerated signal was not obtained.

TABLE 1

| | Evaluation | Hc | | Particle Diameter |
|---|---|---|---|---|
| | of output | (kA/m) | Crystal Structure | (nm) |
| Example 1 | Yes | 276.5 | Tetragonal FePt | 5 |
| Example 2 | Yes | 252.8 | Tetragonal FePt | 5 |
| Example 3 | Yes | 260.7 | Tetragonal FePt | 5 |
| Example 4 | Yes | 387.1 | Tetragonal FePt | 5 |
| Example 5 | Yes | 250.0 | Tetragonal FePt | 5 |
| Comparative | No | 276.5 | Tetragonal FePt | 5 |
| example 1 | | | | |

Table 1 shows that the magnetic recording medium in Comparative Example 1 cannot be used for practical purposes since it was partially deformed by annealing due to low heat resistance of the substrate, although tetragonal magnetic particles were obtained.

On the contrary, it was confirmed that the magnetic recording media in Examples 1 to 5 were able to afford high output with a high coercive force (Hc) without deformation by annealing, since heat resistance of the substrate was high.

The magnetic recording medium of the invention is able to afford high recording density and high output without deformation by annealing.

What is claimed is:

1. A magnetic recording medium having a magnetic layer containing magnetic particles having ferromagnetic regular alloys having a CuAu or Cu₃Au crystal structure, on a substrate, wherein the substrate contains polybenzoxazole, and the magnetic layer is sequentially formed by:
preparing alloy particles capable of forming the ferromagnetic regular alloys having a CuAu or Cu₃Au crystal structure;
forming a coating film by applying the alloy particles on the substrate; and
converting the alloy particles into magnetic particles by annealing the coating film so that the alloy particles are annealed.

2. A magnetic recording medium according to claim 1, wherein oxidizing of the alloy particles is further carried out between preparing the alloy particles and annealing the coating film.

3. A magnetic recording medium according to claim 2, wherein oxidizing of the alloy particles is carried out in an oxygen atmosphere or in air at 0 to 80° C. for 1 to 24 hours.

4. A magnetic recording medium according to claim 1, wherein the polybenzoxazole is poly-p-phenylene benzoxazole.

5. A magnetic recording medium according to claim 1, wherein a thickness of the substrate is in a range of 0.002 to 0.100 mm.

6. A method for producing a magnetic recording medium having a magnetic layer on a substrate containing polybenzoxazole, wherein the magnetic layer is sequentially formed by:
preparing alloy particles capable of forming ferromagnetic regular alloys having a CuAu or Cu₃Au crystal structure;
forming a coating film by applying the alloy particles on the substrate; and
converting the alloy particles into magnetic particles by annealing the coating film so that the alloy particles are annealed.

7. A method according to claim 6, wherein oxidizing the alloy particles is further carried out between preparing the alloy particles and annealing the coating film.

8. A magnetic recording medium according to claim 7, wherein oxidizing of the alloy particles is carried out in an oxygen atmosphere or in air at 0 to 80° C. for 1 to 24 hours.

9. A method according to claim 6, wherein polybenzoxazole is poly-p-phenylene benzoxazole.

10. A method according to claim 6, wherein a thickness of the substrate is in a range of 0.002 to 0.100 mm.
